(19) United States
(12) Patent Application Publication
(10) Pub. No.: US 2009/0025226 A1
(43) Pub. Date: Jan. 29, 2009

(54) MANUFACTURE OF HARDFACED ROLLERS AND PLATES

(75) Inventors: Dorival Goncavales Tecco, Cambridgeshire (GB); Serdar Atamert, Hertfordshire (GB)

Correspondence Address: HARTMAN & HARTMAN, P.C., 552 EAST 700 NORTH, VALPARAISO, IN, 46383, US

(73) Assignee: WELDING ALLOYS LIMITED, Hertfordshire (GB)

(21) Appl. No.: 12/066,332

(22) PCT Filed: Sep. 7, 2006
(86) PCT No.: PCT/GB06/03303

§ 371 Date: Sep. 23, 2008

(30) Foreign Application Priority Data
Sep. 8, 2005 (GB) 0518322.3

(51) Int. Cl. B21K 1/02; H01B 13/22

(52) U.S. Cl. 29/895.3; 29/33 E

(57) ABSTRACT

Apparatus (1) and method for use in the manufacture of hardfaced, clad metal substrates (60), comprising welding means (3) at a cladding location, means (2) for supporting a substrate (60) to be metal clad by the welding means (3) at the cladding location, and means (4) arranged to machine the surface (61) of a so-clad substrate (60) at the cladding location.

This invention relates to the manufacture of hardfaced rollers, plates and similar metal clad products which are used in harsh and demanding working environments where resistance to abrasion, adhesion, erosion, cavitation, oxidation and/or other corrosion is important and which comprise a metallic substrate clad on its working surface, by arc welding, with a hard wearing, oxidation- and/or corrosion-resistant material, such as a steel, low-alloy ferrous material, iron or a high-alloy ferrous material, cobalt-based alloy, nickel-based alloy or a copper-based alloy.

Throughout this specification, the word “manufacture” is used in respect of not only the primary production of hardfaced rollers, plates and other similar metal clad products but also the refurbishment of such products.

A typical technique for manufacturing hardfaced rollers involves a cladding operation by arc welding to the outer surface of a comparatively inexpensive and less durable cylindrical metal substrate which, after such cladding, is demounted from the cladding apparatus and is transported to remote machining apparatus where its now hardfaced, clad surface is machined, for example, by milling, to provide a hardfaced surface of a predetermined depth and, hence, a hardfaced roller of a predetermined diameter, as well as of a desired smoothness.

Such a technique is highly labour intensive and involves transporting the hardfaced rollers from the cladding apparatus to the remote machining apparatus using heavy moving equipment, such as a heavy duty forklift truck. Such demounting, transporting and remounting procedures are, as a consequence, expensive, as well as posing a threat to the health and safety of operatives. Further costs are involved in having the cladding and remote machining apparatus in separate locations.

Also, the clad rollers are machined cold, resulting in a surface whose smoothness could be improved.

It is an object of the present invention to provide apparatus for manufacturing hardfaced rollers, plates or similar clad products, which overcomes, or at least substantially reduces, the disadvantages associated with the present techniques, as discussed above.

Accordingly, a first aspect of the invention resides in apparatus for use in the manufacture of clad metal substrates, such as hardfaced rollers, plates and the like, comprising welding means, such as an arc welding gun, at a cladding location, means for supporting a substrate to be metal clad by the welding means at the cladding location, and means arranged to machine the surface of a so-clad substrate, wherein said machining means is at the cladding location.

In the vast majority of cases, the welding means will be a conventional arc welding gun, although other suitable forms of welding means may also be used.

The welding means, such as the arc welding gun proposed above, is preferably arranged to traverse the width of the metal substrate to be clad with metal. If the substrate is a metal cylinder, then the metal welding means may be arranged to traverse the width of the cylindrical metal substrate, that is to say, to reciprocate the welding means back and forth axially of the substrate mounted upon the support means for rotation about the axis of the substrate.

In such an arrangement, the support means may be of any suitable form but a lathe-type support with a headstock and tailstock is preferred.

Apparatus in accordance with the invention may also be used for manufacturing a hardfaced plate by cladding a sheet metal substrate moving linearly past the welding means, in which case, suitable support means for the sheet substrate of conventional design may be employed.

The means for machining the metal clad surface of the substrate at the cladding location may, again, be of any conventional type. In a preferred embodiment of cladding apparatus to be described hereinbelow, machining of the clad substrate is carried out by a milling device arranged to traverse the surface of the substrate during or after cladding by the welding means.

One option is for the metal machining means to track the welding means as it is cladding the substrate with metal. This arrangement is advantageous, in that the machining means is working upon fresh metal cladding which is still hot, thereby providing cleaner removal of the cladding metal from the surface of the clad substrate and, also, a comparatively smooth surface when compared against previous techniques.

The welding means and metal machining means may be programmed to operate in unison with each other or independently of each other, depending upon operating requirements of the apparatus.

Optionally, the surface of the metal substrate, before and/or after cladding and/or after machining thereof, can be monitored, to control the operation of the welding means and or the machining means, to provide, say, a hardfaced roller of a required metal cladding thickness and diameter and having an improved smoothness.

Such monitoring means preferably comprises laser monitoring means arranged to traverse the width of the substrate in unison with or independently of the welding means and/or machining means, again depending upon operating conditions and requirements.

Such monitoring means may be employed to control operation of the welding means and/or machining means, to provide a metal cladding on the surface of the metal substrate of a desired thickness and/or a clad substrate of a required diameter or thickness, depending upon whether the eventual hardfaced product is in roller or plate form.

Typically, a control unit, preferably programmable, can be employed to monitor and/or control operation of the welding means, machining means and/or monitoring means.

A second aspect of the invention resides in a method of manufacturing a hardfaced, metal-clad substrate, the method comprising cladding a surface of a metal substrate with a metal by welding and then machining the so-clad surface of the substrate, wherein machining of the clad substrate surface is conducted at the location of the welding operation.

Welding is preferably carried out by means of an arc welding gun and the machining of the clad surface of the substrate at the location of the welding operation may be performed by any suitable metal cutting means, although a milling operation is preferred.

If the substrate is a cylindrical metal substrate, then the resulting product is preferably in the form of a hardfaced, metal-clad roller of desired cladding thickness and diameter and, also, with a comparatively smooth surface. However, hardfaced plates may be produced by welding and machining a sheet metal substrate at the cladding location.

Optionally, the surface of the clad substrate may be monitored, preferably by means of a laser device.

The cladding and machining operations may be arranged to be performed in unison with or independently of each other, depending upon operating requirements. Similarly, the surface monitoring operation, such as that carried out by an optional laser device, may be carried out independently of or in unison with the cladding and/or machining operations and may also be used to control such operation(s).

In both aspects of the invention defined above, as well as any modifications thereof, the metal substrate may be of any suitable metal, such as a steel, whilst the cladding metal may be any suitable metallic material, such as a steel, low-alloy ferrous material, iron or a high-alloy ferrous material or a cobalt-, nickel- or copper-based alloy.

In order that the invention may be more fully understood, apparatus in accordance therewith and for manufacturing a hardfaced roller for use in a steel rolling plant will now be described by way of example and with reference to the accompanying drawings in which:

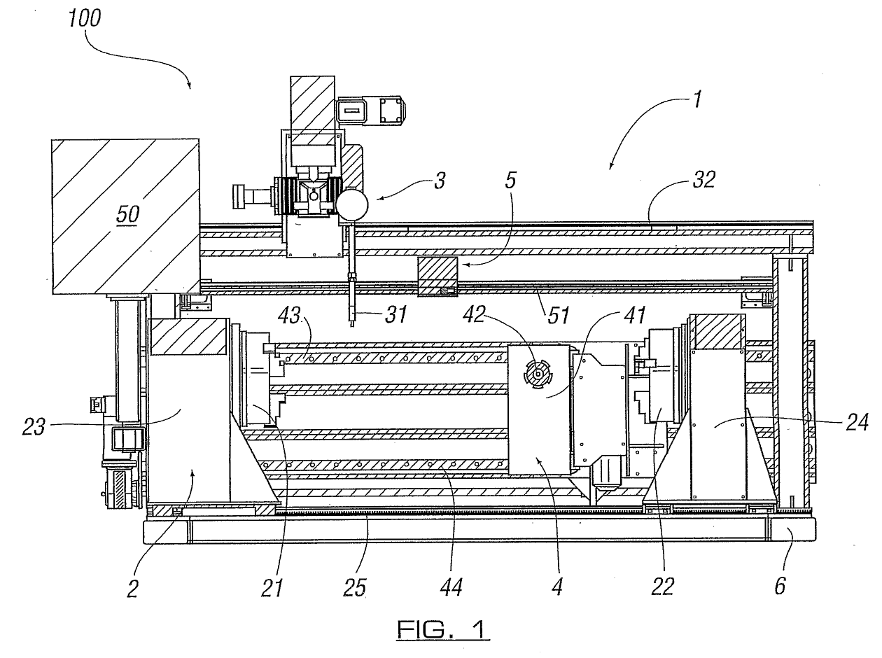

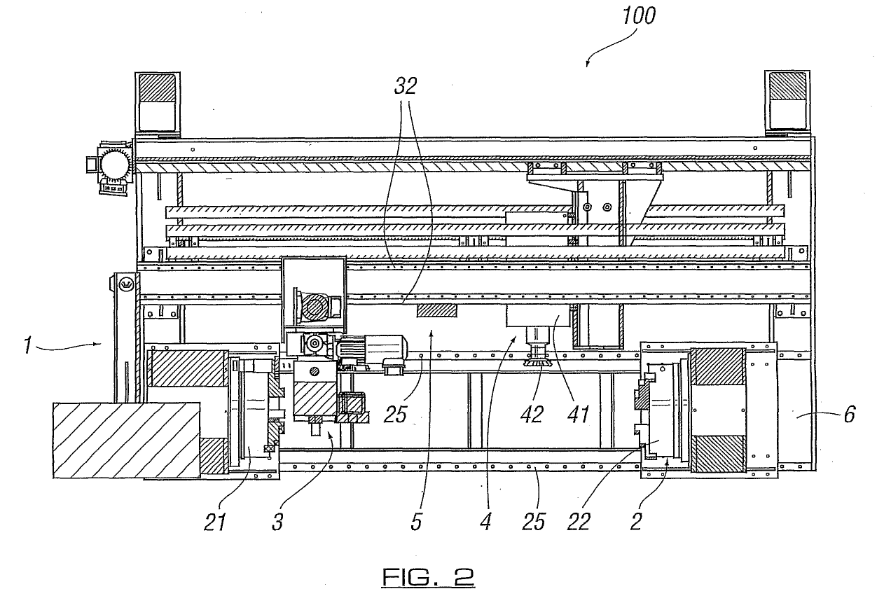

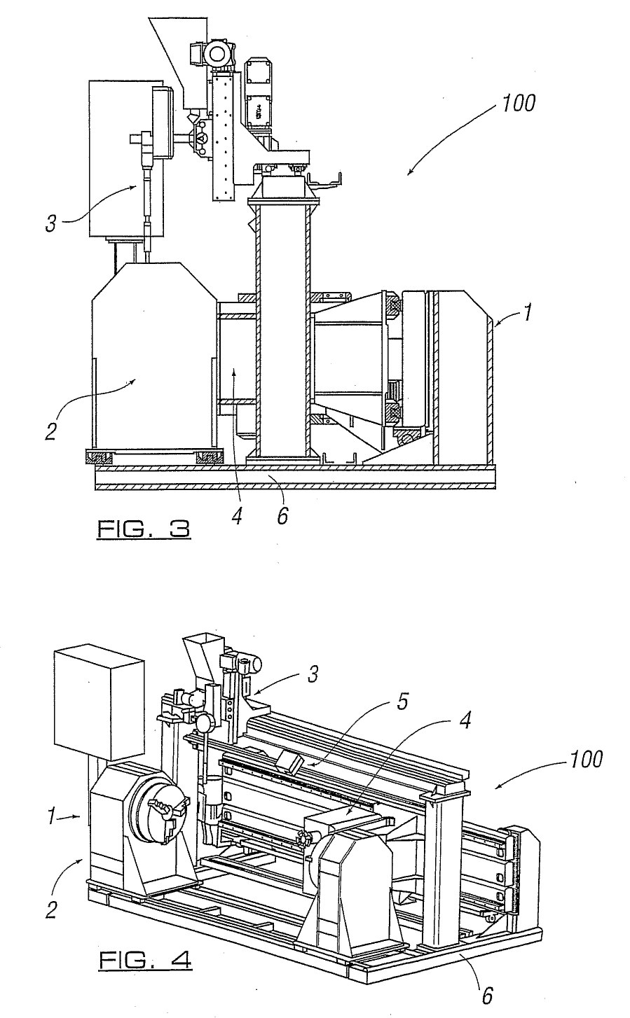

FIGS. 1 to 4 are respective front elevational, plan, side elevational and perspective views of hardfaced roller manufacturing apparatus;

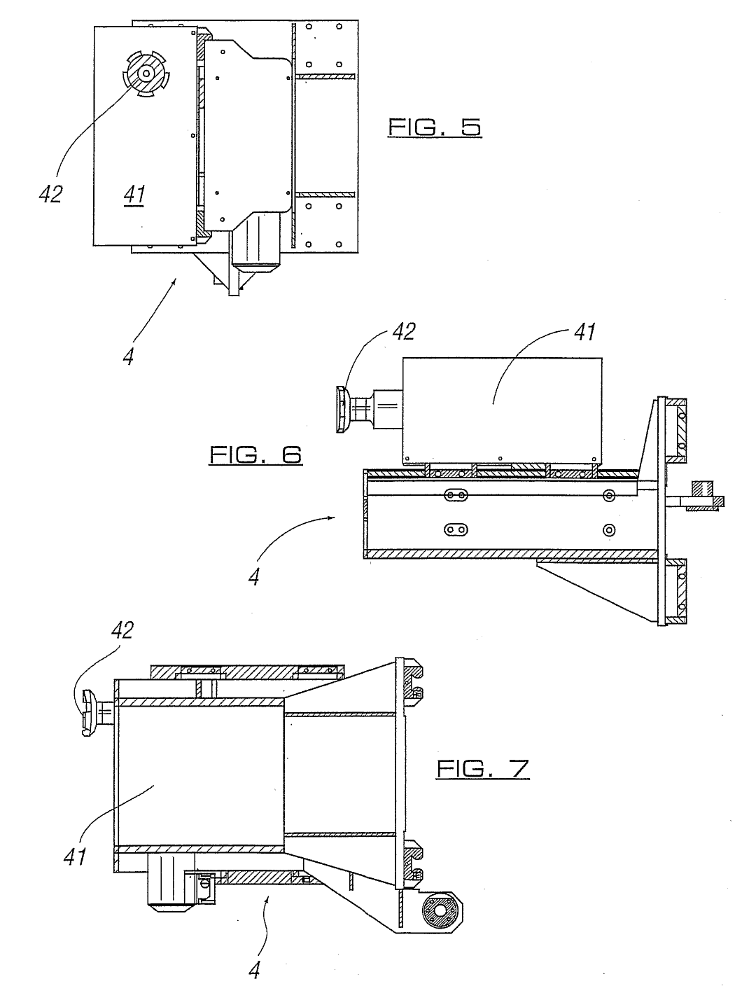

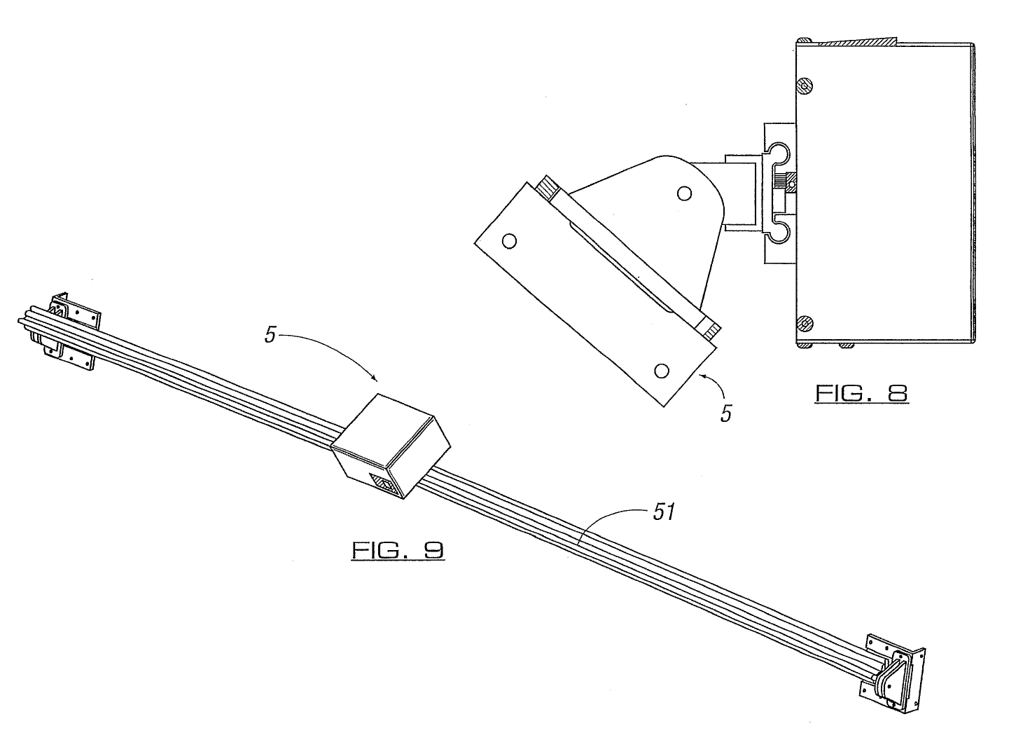

FIGS. 5 to 7 are respective front elevational, plan and side elevational views of a milling device used in the apparatus shown in FIGS. 1 to 4;

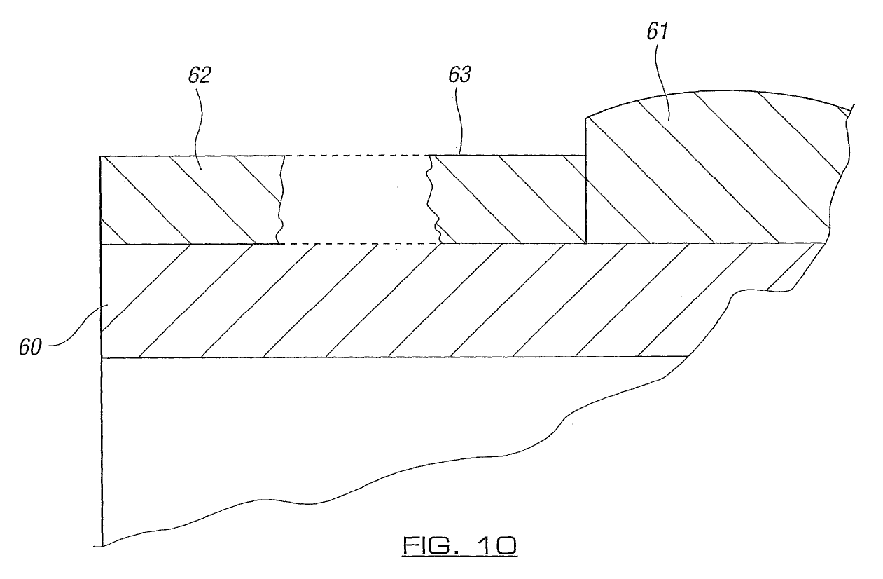

FIGS. 8 and 9 are respective side elevational and perspective views of a laser monitoring device used in the apparatus shown in FIGS. 1 to 4; and

FIG. 10 is a diagrammatic section, not to scale, of a partially clad and machined hardfaced roller.

Referring firstly to FIGS. 1 to 4 of the accompanying drawings, apparatus, indicated generally at 1, for manufacturing a hardfaced roller (not shown) for use in a steel rolling plant, comprises four main components at a cladding location 100, namely:
a device similar to a lathe and indicated generally at 2 for rotatably supporting a metal cylinder (not shown), as a substrate, to be clad with a metal by arc welding;
an arc welding device indicated generally at 3 for cladding the surface of the metal cylinder with metal;
a device indicated generally at 4 for machining the metal-clad surface of the cylinder; and
a laser device indicated generally at 5 for monitoring the metal-clad surface and/or the unclad surface of the cylinder.

The apparatus 1 comprises a bed 6 upon which the devices 2 to 5 are mounted at the cladding location 100.

The lathe-type device 2 comprises a headstock 21 mounted rotatably in conventional manner to a drive unit 23 which is fixed with respect to the bed 6. A tailstock 22 is mounted rotatably to another unit 24 which is mounted upon bed rails 25 for linear movement towards and away from the drive unit 23 and associated headstock 21, again in known manner.

The axially opposed ends of a metal cylinder (not shown) to be metal clad can be mounted to respective ones of the headstock 21 and tailstock 22 for rotation with respect to the arc welding device 3 about an axis generally perpendicular to the longitudinal axis of the arc welding gun of the device 3.

The device 3 is mounted upon a pair of upper rails 32 for linear movement for direction parallel to the axis of the metal cylinder to be clad, so that a welding gun 31, and its associated components, such as wire feed and power supply, can be moved axially back and forth with respect to the cylinder to traverse the surface thereof.

The metal surface machining device 4 comprises a conventional drive unit 41 and a milling head 42, the unit 41 being mounted upon a pair of vertical-spaced rails 43,44 which also extend parallel to the axis of a metal cylinder to be clad with metal as well as to the bedrails and the upper rails 32.

A control unit 50 is provided for controlling operation of the components of the apparatus 1.

In use of the apparatus 1, a metal cylinder to be clad with metal is mounted to the lathe-type support device 2, as discussed above. The metal cylinder is of any suitable metallic material, usually a steel.

Upon rotation of the cylinder by the support device 2, the welding device 3 reciprocates back and forth along the axial length of the metal cylinder, with the tip of the arc welding gun 31 at the required distance from the surface of the cylinder.

Such movement of the arc welding device 3 along its associated upper rails 32 is, in this particular embodiment, tracked by movement of the drive unit 41, and hence the milling head 42, of the machining device 4 along its associated rails 43,44 extending parallel to the upper rails 32 of the welding device 3.

The distance of the milling head 42 is set, such that it machines the metal clad surface of the cylinder to a required thickness, depending upon the eventual application of the resulting hardfaced roller.

Also, because the milling head 42 tracks closely the arc welding gun 31, machining of the so-clad surface of the cylinder is facilitated, because the cladding metal is still hot. As a consequence, a comparatively smooth clad surface for the eventual hardfaced roller is provided.

The laser monitoring device 5, which is mounted for linear movement along a rail 51 extending parallel to the rails 25,43 and 44, and 32, can be used to monitor the surface of the cylinder, whether it be unclad, partially-clad or fully clad, for controlling operation of the support device 2, for example, the rotational speed thereof and hence that of the metal cylinder to be or being clad, the arc welding device 3 and/or the machining device 4, to provide the required thickness and smoothness of the surface of the cylinder clad by the arc welding device 3.

In FIG. 10, there is shown an end portion of a metal cylinder 60 which has been at least partially clad with metal by arc welding, as discussed and described above. The metal cladding after the arc welding procedure but prior to its machining is indicated at 61. It may have a typical thickness of, say, 3 mm. The machined metal cladding is shown at 62 with a smooth surface 63, its typical thickness being 2 mm.

As indicated above, the cylinder 60 may be of any suitable metallic material, for example, a steel, whilst the cladding metal might typically be a steel, low-alloy ferrous material, iron or a high-alloy ferrous material or a cobalt-, nickel- or copper-based alloy.

Although the preferred embodiment described above in relation to the accompanying drawings involves the manufacture of a hardfaced roller for use in a steel rolling plant, it is to be appreciated that the manufacturing apparatus and method in accordance with the invention could also be applied to the production of hardfaced plates.

Thus, it can be seen that the invention provides apparatus for and a method of manufacturing by arc welding and machining clad metal substrates, such as hardfaced rollers, plates and other similar hardfaced products, at a single, cladding location which involve, inter alia, less manpower, manufacturing space, time and expense than previously-known arc welding cladding techniques, whilst also providing hardfaced rollers, plates and other similar clad products with working surfaces which are generally smoother than those of hardfaced products manufactured by known cladding techniques.

1-22. (canceled)

23: An apparatus for use in the manufacture of clad metal substrates, comprising welding means at a cladding location, means for supporting a substrate to be metal clad by the welding means at the cladding location, and means for machining the surface of a so-clad substrate, wherein the machining means is at the cladding location.

24: The apparatus according to claim 23, wherein the welding means is an arc welding gun.

25: The apparatus according to claim 23, wherein the welding means is arranged to traverse the width of the substrate to be clad with metal.

26: The apparatus according to claim 23, wherein the welding means is arranged to traverse the width of a cylindrical metal substrate to be metal clad, to reciprocate the welding means back and forth axially of the substrate mounted upon the support means for rotation about the axis of the substrate.

27: The apparatus according to claim 23, wherein the support means is a lathe-type support with a headstock and tailstock.

28: The apparatus according to claim 23, wherein the machining means is a milling device arranged to traverse the surface of the substrate during or after cladding by the welding means.

29: The apparatus according to claim 23, wherein the machining means is arranged to track the welding means as it is cladding the substrate with metal.

30: The apparatus according to claim 23, wherein the welding means and metal machining means are programmed to operate in unison with each other or independently of each other.

31: The apparatus according to claim 23, further comprising means arranged to monitor the surface of a metal substrate before and/or after cladding and/or after machining thereof, to control the operation of the welding means and/or the machining means.

32: The apparatus according to claim 31, wherein the monitoring means comprises laser monitoring means arranged to traverse the width of the substrate in unison with or independently of the welding means and/or machining means.

33: The apparatus according to claim 31, wherein the monitoring means is arranged to control operation of the welding means and/or machining means.

34: The apparatus according to claim 23, further comprising a control unit to monitor and/or control operation of the welding means and/or machining means.

35: The apparatus according to claim 34, wherein the control unit monitors and/or controls operation of the monitoring means.

36: A method of manufacturing a hardfaced, metal-clad substrate, the method comprising cladding a surface of a metal substrate with a metal by welding and then machining the clad surface of the substrate at the location of the welding operation.

37: The method according to claim 36, wherein the welding step is carried out by means of an arc welding gun.

38: The method according to claim 36, wherein the machining step of the clad surface of the substrate is performed by a milling operation.

39: The method according to claim 36, wherein the clad surface of the substrate is monitored.

40: The method according to claim 39, wherein the monitoring step is carried out by means of a laser device.

41: The method according to claim 36, wherein the cladding step and machining steps are arranged to be performed in unison with or independently of each other.

42: The method according to claim 39, wherein the monitoring step is carried out independently of or in unison with the cladding and/or machining steps.

43: The method according to claim 42, wherein the monitoring step controls the cladding and/or machining steps.

44: The method according to claim 36, wherein the substrate is cylindrical or a sheet metal substrate.
